(19) United States
(12) Patent Application Publication
(10) Pub. No.: US 2008/0070645 A1
(43) Pub. Date: Mar. 20, 2008

(54) ELECTRONIC DEVICE AND ASSEMBLY OF CABLE AND FLEXIBLE PRINT CIRCUIT THEREOF

(75) Inventor: Yung Tsun Hsieh, Changhua (TW)

Correspondence Address: QUINTERO LAW OFFICE, PC, 2210 MAIN STREET, SUITE 200, SANTA MONICA, CA, 90405, US

(73) Assignees: QISDA CORPORATION, Taoyuan County (TW); BENQ CORPORATION, Taipei (TW)

(21) Appl. No.: 11/858,722

(22) Filed: Sep. 20, 2007

(30) Foreign Application Priority Data
Sep. 20, 2006 (TW) TW95134788

(51) Int. Cl. H04M 1/03; H01R 12/08

(52) U.S. Cl. 455/575.3; 439/63; 439/77

(57) ABSTRACT

An assembly of a cable and a flexible print circuit includes a flexible print circuit, a first joining element joined to the flexible print circuit and having a profile similar thereto, and at least one cable fixed to the first joining element. A gap is formed between the first joining element and the flexible print circuit.

### BACKGROUND OF THE INVENTION

1. Field of the Invention

The invention relates to an assembly of a cable and a flexible print circuit of an electronic device.

2. Description of the Related Art

Handheld electronic devices, such as PDAs, mobile phones, digital cameras, are very popular. For a hinged handheld electronic device 100 as shown in FIG. 1, electronic elements are disposed in the cover 10 and main body 20. For example, a screen 12 or a speaker 14 can be disposed on the cover 10, with a keypad and battery disposed in the main body 20. FIG. 2 is an exploded view of FIG. 1. FIG. 3 is an enlarged view of portion A in FIG. 2. A first circuit board 15 and a second circuit board 25 are disposed in the cover 10 and the main body 20. The first circuit board 15 is electrically connected to the second circuit board 25 by a flexible print circuit board 30. FIG. 4 depicts the first circuit board 15, the second circuit board 25 and the flexible print circuit board 30.

Typically, a flexible print circuit board as used in a hinge of an electronic device, shown in FIGS. 5 and 6, has multiple layers 31. An adhesive layer 32 disposed between two layers 31 binds the layers 31 and forms a gap 34 therebetween. As the flexible print circuit on the hinge must flex, such a structure of multiple layers reduces additional tress caused by unequal strain on the flexed layers to increase lifetime of the flexible print circuit.

As handheld electronic devices provide increased functionality, more signals are transmitted. EMI, EMC has become a problem. Coaxial cables are used to reduce the EMI, EMC problems. To reduce cost, the flexible print circuit board is combined with the coaxial cable transmitting signals which are needed to be isolated from EMI, such as RF signals.

A conventional assembly of a cable and a flexible print circuit board is disclosed in US Pub. No. 20030211873, which comprises a large hinge and complicated structure.

If the coaxial cable is directly joined to the flexible print circuit board, the rigidity of the cable increases stress in the flexible circuit board when the assembly is flexed.

### BRIEF SUMMARY OF INVENTION

An embodiment of an assembly of a cable and a flexible print circuit of the invention comprises a flexible print circuit, a first joining element joined to the flexible print circuit and having a profile similar to the flexible print circuit, and at least one cable fixed to the first joining element. A gap exists between the first joining element and the flexible print circuit.

The assembly further comprises a second joining element covering the cable and the first joining element to position the cable between the first and second joining elements.

The assembly further comprises at least one adhesive layer disposed between the first joining element and the flexible print circuit to form the gap between the first joining element and the flexible print circuit. The flexible print circuit is N-shaped and disposed on a hinge position. The adhesive layer is disposed on two ends of the N-shaped flexible print circuit.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 shows a conventional handheld electronic device; and

FIG. 2 is a partially exploded view of FIG. 1;

FIG. 3 is an enlarged view of portion A of FIG. 2;

FIG. 4 depicts the first circuit board, the second circuit board and the flexible print circuit of FIG. 3;

FIGS. 5 and 6 depict a conventional flexible print circuit disposed on a hinge;

FIG. 7 shows a flexible print circuit of the invention disposed on a hinge;

FIG. 8 depicts a coaxial cable assembled to the flexible print circuit of FIG. 7;

FIG. 9 is an assembled view of FIG. 8;

FIGS. 10 and 11 are assembled views of a coaxial cable and the flexible print circuit;

FIG. 12 is a cross section of an embodiment of an assembly of a cable and a flexible print circuit of the invention;

FIG. 13 is a perspective view of another embodiment of an assembly of a cable and a flexible print circuit of the invention;

FIG. 14 is a cross section of another embodiment of an assembly of a cable and a flexible print circuit of the invention; and

FIG. 15 is a cross section of another embodiment of an assembly of a cable and a flexible print circuit of the invention.

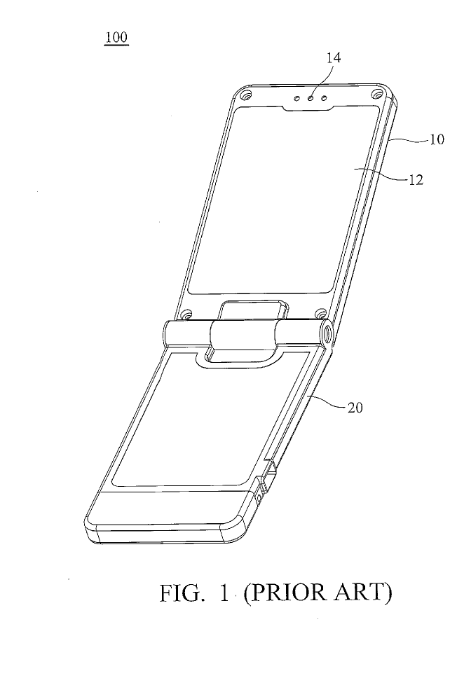

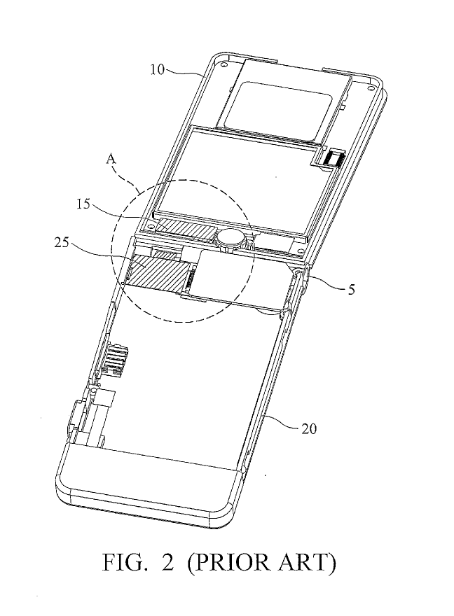

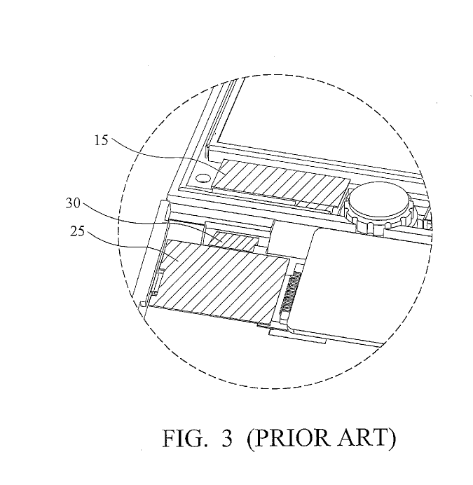

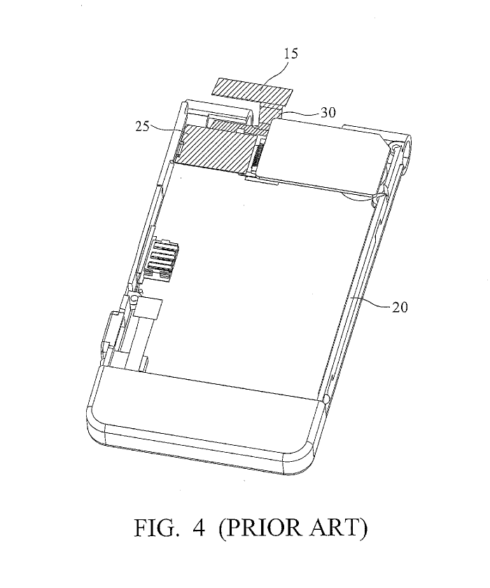

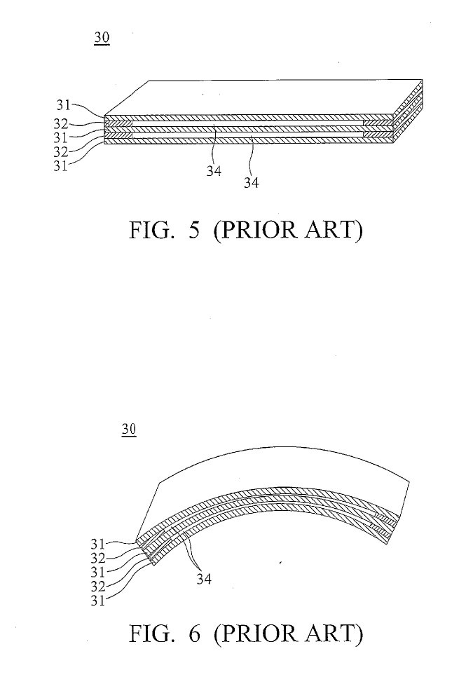

### DETAILED DESCRIPTION OF INVENTION

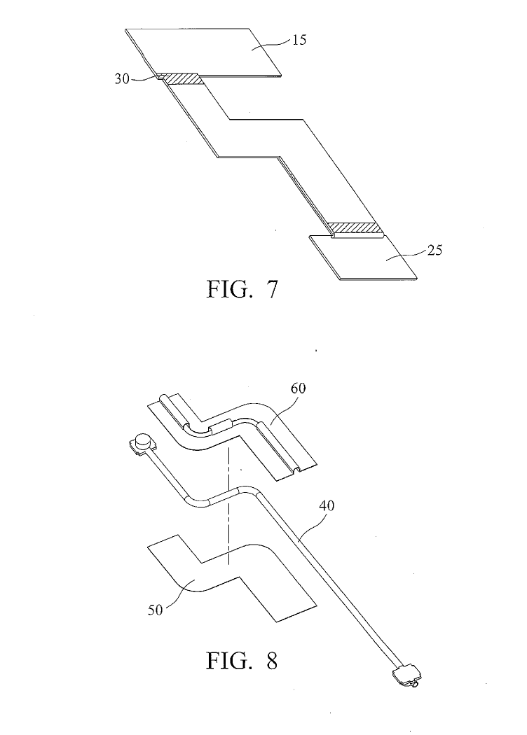

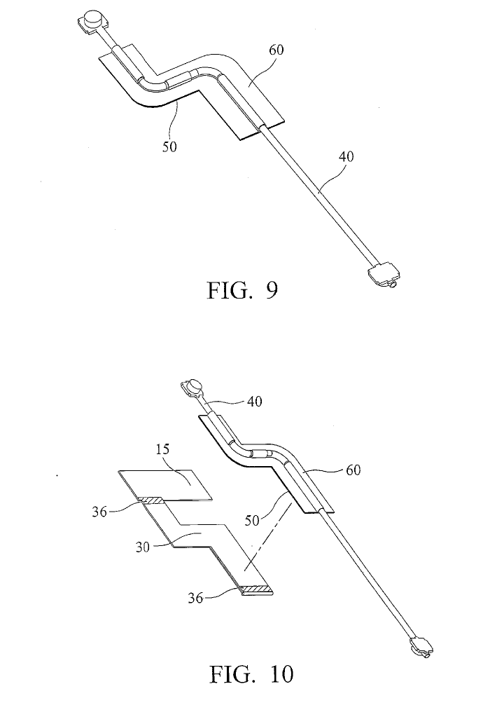

Referring to FIG. 7, a flexible print circuit 30 disposed in a hinge position is N-shaped, conforming to the hinge. Two ends of the flexible print circuit 30 are connected to a first circuit board 15 and a second circuit board 25 respectively. Referring to FIG. 8, a coaxial cable 40 is flexed to an N-shape. Referring to FIGS. 9 and 10, an assembly of a cable and a flexible print circuit comprises a flexible print circuit 30, a coaxial cable 40, a first joining element 50 and a second joining element 60. The first joining element 50 and the second joining element 60 are N-shaped. The second joining element 60 has a protruding accommodating portion 62 with which the coaxial cable 40 engages. The second joining element 60 is fixed to the first joining element 50, whereby the coaxial cable 40 is fixed between the first joining element 50 and the second joining element 60 as shown in FIG. 9.

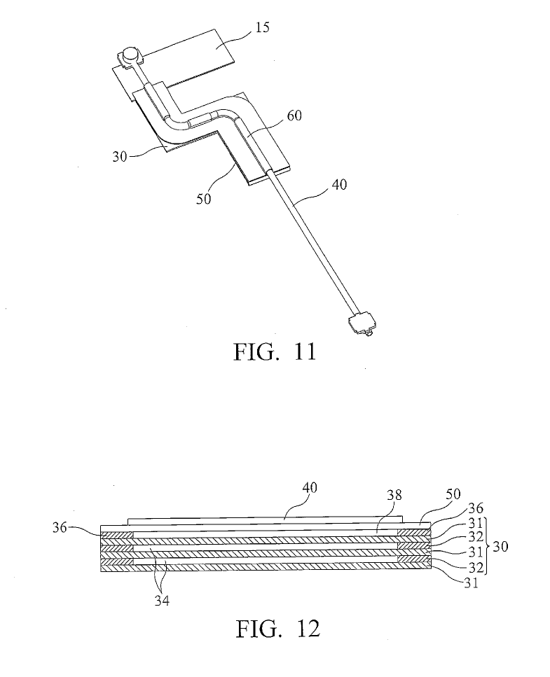

An adhesive layer 36 is disposed at both ends of the N-shaped flexible print circuit 30 as shown in FIG. 10. The coaxial cable 40, along with the first joining element 50 and the second joining element 60 is fixed to the flexible print circuit 30 by the adhesive layer 36 as shown in FIG. 11.

Referring to FIG. 12, a gap 38 is formed between the first joining element 50 and the flexible print circuit 30 by the adhesive layer 36. The gap 38 reduces stress on the flexible print circuit 30 and increases lifetime thereof when the flexible print circuit 30 and the coaxial cable 40 flex at the hinge.

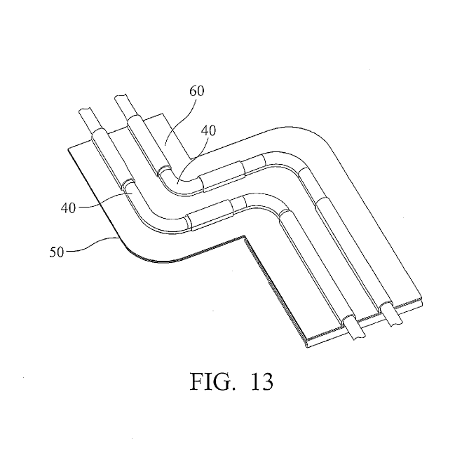

Although this embodiment discloses the flexible print circuit joined to only one coaxial cable, two or more coaxial cables can alternatively be joined to the flexible print circuit in such a structure according to requirements. FIG. 13 depicts two parallel coaxial cables 40 joined to the flexible print circuit 30.

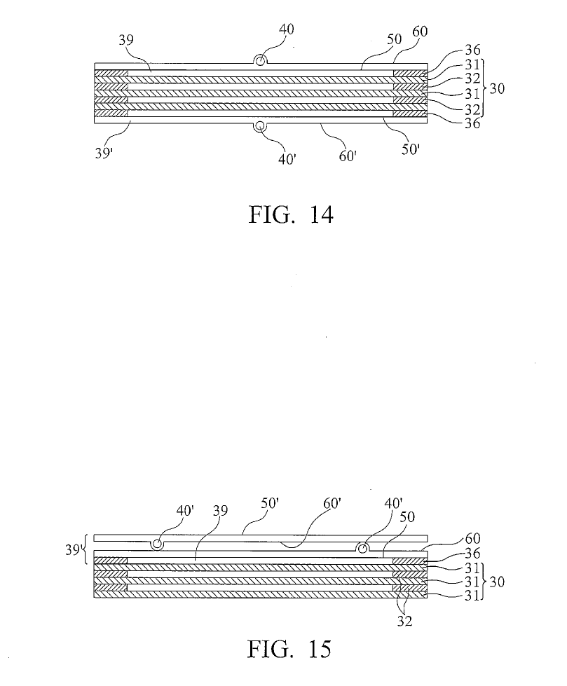

Other embodiments of the invention are shown in FIGS. 14 and 15. As shown in FIG. 14, two coaxial cables (first and second cables) 40 and 40′ are positioned on two sides of the flexible print circuit 30. The first joining element 50 and a third joining element 50′ are fixed to two sides of the flexible print circuit 30 by the adhesive layers 36 to form a first gap 39 and a second gap 39′. The second joining element 60 and a fourth joining element 60′ fix the coaxial cables 40 and 40′ to the first joining element 50 and the third joining element 50′.

As shown in FIG. 15, two coaxial cables 40 and 40′ are on the same side of the flexible print circuit 30. The first joining element 50 is fixed to the flexible print circuit 30 by an adhesive layer 36 to form a first gap 39. The second coaxial cable 40′, along with the third joining element 50′ and the fourth joining element 60′ is fixed to the second joining element 60.

As a gap is formed between the first joining element and the flexible print circuit, stress on the flexible print circuit 30 is reduced when the coaxial cable 40 and the flexible print circuit 30 are flexed.

The assembly of cables and the flexible print circuit is applicable to handheld electronic devices, such as mobile phones, or PDAs. The coaxial cable can transmit power, blue tooth signals, wireless 802.1b signals and GPS, GSM or CDMA signals.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An assembly of a cable and a flexible print circuit, comprising:
a flexible print circuit;
a first joining element joined to the flexible print circuit and having a profile similar to the flexible print circuit; and
at least one cable fixed to the first joining element, wherein a gap exists between the first joining element and the flexible print circuit.

2. The assembly of a cable and a flexible print circuit as claimed in claim 1 further comprising a second joining element covering the cable and the first joining element to position the cable between the first and second joining elements.

3. The assembly of a cable and a flexible print circuit as claimed in claim 1 further comprising at least one adhesive layer disposed between the first joining element and the flexible print circuit to form the gap between the first joining element and the flexible print circuit.

4. The assembly of a cable and a flexible print circuit as claimed in claim 3, wherein the flexible print circuit is N-shaped and disposed on a hinge position.

5. The assembly of a cable and a flexible print circuit as claimed in claim 4, wherein the adhesive layer is disposed on two ends of the N-shaped flexible print circuit.

6. The assembly of a cable and a flexible print circuit as claimed in claim 1, wherein the flexible print circuit is N-shaped and disposed on a hinge position.

7. An electronic device, comprising:
a first element;
a second element;
a hinge connecting the first and second elements, whereby the first element is rotatably connected to the second element;
a flexible print circuit disposed on the hinge and electrically connected to the first element and the second element;
a first joining element joined to the flexible print circuit and having a profile similar to the flexible print circuit; and
at least one cable fixed to the first joining element, wherein a gap exists between the first joining element and the flexible print circuit

8. The electronic device as claimed in claim 7 further comprising a second joining element covering the cable and the first joining element to position the cable between the first and second joining elements.

9. The electronic device as claimed in claim 7 further comprising at least one adhesive layer disposed between the first joining element and the flexible print circuit to form the gap between the first joining element and the flexible print circuit.

10. The electronic device as claimed in claim 9, wherein the flexible print circuit is N-shaped.

11. The electronic device as claimed in claim 10, wherein the adhesive layer is disposed on two ends of the N-shaped flexible print circuit.

12. The electronic device as claimed in claim 7, wherein the flexible print circuit is N-shaped.

13. An electronic device, comprising:
a first element;
a second element;
a hinge connecting the first and second elements, whereby the first element is rotatably connected to the second element;
a flexible print circuit disposed on the hinge and electrically connected to the first element and the second element;
a first joining element joined to the flexible print circuit and having a profile similar to the flexible print circuit;
a first cable electrically connecting the first and second elements and fixed to the first joining element;
a third joining element joined to the flexible circuit board and having a profile similar to the flexible print circuit;
a second cable electrically connecting the first and second elements and fixed to the third joining element, wherein a first gap exists between the first joining element and the flexible circuit element and a second gap exists between the third joining element and the flexible print circuit.

14. The electronic device as claimed in claim 13, wherein the flexible print circuit is disposed between the first cable and the second cable.

15. The electronic device as claimed in claim 13, wherein the first cable is disposed between the second cable and the flexible print circuit.
